(19) United States
(12) Patent Application Publication
(10) Pub. No.: US 2026/0352350 A1
(43) Pub. Date: Nov. 5, 2026

(54) METHODS AND APPARATUSES FOR ENERGY-AWARE WIRELESS COMMUNICATION

(71) Applicant: HUAWEI TECHNOLOGIES CO., LTD., SHENZHEN (CN)

(72) Inventors: Mahmoud HASABELNABY, Kanata (CA); Osama ABOUL-MAGD, Kanata (CA); Yan XIN, Kanata (CA); Jung Hoon SUH, Kanata (CA); Abdalla Mohamed Abdelaziz Mahmoud HUSSEIN, Kanata (CA)

(73) Assignee: HUAWEI TECHNOLOGIES CO., LTD., SHENZHEN (CN)

(21) Appl. No.: 19/338,150

(22) Filed: Sep. 24, 2025

Related U.S. Application Data
(60) Provisional application No. 63/798,215, filed on May 1, 2025.

(51) Int. Cl. H04B 17/318; H04L 5/00; H04W 52/36

(52) U.S. Cl. CPC H04B 17/318; H04L 5/0053; H04W 52/367

(57) ABSTRACT

Apparatuses and methods for energy-aware communication in a wireless network are provided. An ambient power communication (AMP) station (STA) may leverage its uplink (UL) transmissions to include a one-bit Energy Level Status indication therein. An access point (AP) may schedule providing transmissions to the AMP STA, such as an acknowledgement (ACK) Status indication, according to the Energy Level Status indication received for the AMP STA. The AP may delay transmissions if the current energy level of the AMP STA, as indicated using the Energy Level Status indication, is insufficient to receive and optionally process such transmissions. The AP may leverage its outgoing transmissions, such as AMP frames, to the AMP STA, to include the ACK Status indication therein. The ACK Status indication may include a single bit.

### CROSS-REFERENCE TO RELATED APPLICATION

This application claims priority to U.S. Provisional Patent Application No. 63/798,215, filed May 1, 2025, the contents of which are incorporated herein by reference.

### TECHNICAL FIELD

The present disclosure pertains to the field of wireless communication, and in particular, to methods and systems for energy-aware wireless communication.

### BACKGROUND

Internet-of-things (IoT) networks operating under wireless Wi-Fi® protocols have seen widespread deployment. Features such as utilization of an unlicensed frequency band for communications has made these networks attractive for a range of applications. However, Wi-Fi® IoT technologies cannot meet the needs of all situations. For example, IoT devices powered by conventional batteries may not be suitable for deployment in certain environments, such as those with high pressures, extreme temperatures, or humidity. They may also not be suitable for situations where maintenance-free devices are required, such as when battery replacement is not possible. In some other situations, there may be requirements for devices to be ultra-low complexity or small, such as with a thickness of millimeters, which existing Wi-Fi® IoT technologies may not meet.

Ambient Power communication (AMP) devices represent a new generation of IoT devices. These devices operate on energy harvested from ambient power sources, such as radio waves, solar power, heat, motion, and vibrations. This can eliminate the need for the device to have a conventional battery. AMP devices are typically characterized by ultra-low power consumption, which can peak below 1 milliwatt (mW) and can be due to a low density of ambient power. AMP devices can further be small and sufficiently simple for cost-effective deployment in most applications. In addition, they can be compatible with legacy infrastructure.

In order for AMP devices to perform their intended functions, they must be able to harvest sufficient energy from their surroundings. Functions can, for example, include collecting data, recording measurements, retaining memory, and transmitting data to a network. These functions consume the energy harvested by the device, which must be replenished once a certain amount is used in order for the device to continue functioning.

The study AMP IoT devices was first introduced in the 3rd Generation Partnership Project (3GPP™) TR 22.840 V19.0.0 (2023-12) document, titled “Study on Ambient power-enabled Internet of Things (Release 19)” [3GPP™ TR 22.840 V19.0.0 (2023-12), “3rd Generation Partnership Project; Technical Specification Group Services and System Aspects; Study on Ambient power-enabled Internet of Things (Release 19)”]. The issue tackled in this proposal for Wireless Local Area Network (WLAN) environment was also introduced in the 3GPP™ TS 22.369 V10.1 (2023-12) document, titled “Service requirements for ambient power-enabled IoT; Stage 1 (Release 19)” [3GPP TS 22.369 V1.0.1 (2023-12), “3rd Generation Partnership Project; Technical Specification Group TSG SA; Service requirements for ambient power-enabled IoT; Stage 1 (Release 19), section 4.2”].

In the recent IEEE™ 802.11bp standard, modifications to the Medium Access Control layer (MAC) and Physical Layers (PHY) directed at enabling the operation of an AMP station (STA) that is powered using energy harvesting have been introduced. The power level of an AMP STA may take some time to increase to a level that can support downlink (DL) and uplink (UL) transmissions without interruptions due to insufficient power.

Therefore, there is a need for a method, apparatus, and system for wireless communication that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

According to an aspect of the present disclosure, there is provided a method that includes forming, at an ambient power communication (AMP) station (STA) of a wireless network, an uplink (UL) physical layer protocol data unit (PPDU) that includes a one-bit Energy Level Status indication indicating an energy level of the AMP STA. The method includes transmitting the UL PPDU to an access point (AP) of the wireless network.

According to an implementation, the method may include receiving, at the AMP STA, from the AP, an AMP frame that includes a one-bit acknowledgement (ACK) Status indication indicating one of the UL PPDU was received at the AP, and the UL PPDU was not received at the AP. The UL PPDU may be a first UL PPDU, the one-bit ACK status indication may indicate that the first UL PPDU was received at the AP, and the AMP frame may be one of: an AMP Trigger frame soliciting a second UL PPDU, an AMP Trigger frame scheduling a downlink (DL) PPDU, an AMP ACK frame, an AMP Beacon frame, an AMP Data frame, and another AMP type frame.

The UL PPDU may be a first UL PPDU, the one-bit ACK status indication may indicate that the first UL PPDU was received at the AP, and the AMP frame may be an AMP Trigger frame soliciting a second UL PPDU from the AMP STA. The ACK Status indication may be a one-bit ACK Status indication. The ACK Status indication may indicate that the UL PPDU was not received at the AP, and the method may include retransmitting, by the AMP STA, the UL PPDU to the AP.

According to an implementation, the method may include determining, at the AMP STA, that the energy level of the AMP STA is sufficient for transmitting the UL PPDU to the AP. The method may include receiving, at the AMP STA, from the AP, an acknowledgement (ACK) Status indication indicating one of: the UL PPDU was received at the AP, and the UL PPDU was not received at the AP. The method may include determining, at the AMP STA, that the energy level of the AMP STA is further sufficient for receiving an acknowledgement (ACK) Status indication, from the AP, after transmitting the UL PPDU to the AP. The method may include determining, at the AMP STA, that the energy level of the AMP STA is insufficient to transmit the UL PPDU and receive an ACK Status indication, and delaying, at the AMP STA, the transmission of the UL PPDU until the energy level of the AMP STA is sufficient to transmit the UL PPDU and receive the ACK Status indication.

According to an implementation, the one-bit Energy Level Status indication may indicate that the energy level of the AMP STA is below a threshold value, and the method may include receiving, at the AMP STA, from the AP or an energizer device, an energy signal for increasing the energy level of the AMP STA. The energy signal may include an acknowledgement (ACK) Status indication indicating one of: the UL PPDU was received at the AP, and the UL PPDU was not received at the AP.

According to an aspect of the present disclosure, there is provided a method that includes receiving, at an access point (AP) of a wireless network, from an ambient power communication (AMP) station (STA) of the wireless network, an uplink (UL) physical layer protocol data unit (PPDU) that includes a one-bit Energy Level Status indication indicating an energy level of the AMP STA. The method includes determining, in accordance with the one-bit Energy Level Status indication that the AMP STA is operable to receive, from the AP, an acknowledgement (ACK) Status indication. The method includes transmitting, by the AP, to the AMP STA, the (ACK) Status indication to indicate to the AMP STA that the UL PPDU was received at the AP.

According to an implementation, transmitting, by the AP, to the AMP STA, the ACK Status indication may include forming, at the AP, an AMP frame that includes the ACK Status indication, the ACK Status indication consisting of a single bit, and transmitting, by the AP, the AMP frame to the AMP STA. The UL PPDU may be a first UL PPDU, and the AMP frame may be one of: an AMP Trigger frame soliciting a second UL PPDU, an AMP Trigger frame scheduling a downlink (DL) PPDU, an AMP ACK frame, an AMP Beacon frame, an AMP Data frame, and another AMP type frame. The UL PPDU may be a first UL PPDU, the ACK Status indication may indicate that the first UL PPDU was received at the AP, and the AMP frame may be an AMP Trigger frame soliciting a second UL PPDU from the AMP STA.

According to an implementation, transmitting, by the AP, to the AMP STA, the ACK Status indication may include forming, at the AP, an energy signal for increasing an energy level of the AMP STA, the energy signal including the ACK Status indication, the ACK Status indication consisting of a single bit, and transmitting, by the AP, the energy signal to the AMP STA.

According to an implementation, transmitting, by the AP, to the AMP STA, the ACK Status indication may include transmitting, by the AP, to an energizer device, the ACK Status indication. The energizer device may be configured to form an energy signal for charging the AMP STA, the energy signal including the ACK Status indication, the ACK Status indication consisting of a single bit, and transmit the energy signal to the AMP STA.

According to an aspect of the present disclosure, there is provided a method that includes, at an access point (AP) of a wireless network, determining that a previously solicited uplink (UL) physical layer protocol data unit (PPDU) was not received from an ambient power communication (AMP) station (STA) of the wireless network, and sending, to the AMP STA, an acknowledgement (ACK) Status indication indicating that the UL PPDU was not received at the AP, the ACK Status indication also indicating to the AMP STA that the UL PPDU is to transmitted to the AP.

According to an aspect of the present disclosure, there is provided a method that includes receiving, at an access point (AP) of a wireless network, from an ambient power communication (AMP) station (STA) of the wireless network, a first uplink (UL) physical layer protocol data unit (PPDU). The method includes forming an AMP frame to solicit a second UL PPDU from the AMP STA, the AMP frame including a one-bit acknowledgement (ACK) Status indication for the first UL PPDU. The method includes transmitting the AMP frame to the AMP STA.

According to an aspect of the present disclosure, there is provided an apparatus in a wireless network. The apparatus includes a processor and a memory, the memory includes machine executable instructions, which, when executed by the processor, configure the apparatus to perform any one of the methods described above.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided an apparatus including one or more processors functionally connected to one or more memories for performing the above-described methods.

According to one aspect of this disclosure, there is provided one or more non-transitory computer-readable storage devices including computer-executable instructions, wherein the instructions, when executed, cause one or more circuits to perform the above-described methods.

According to one aspect of this disclosure, there is provided an apparatus, and configured to perform any one of the above mentioned methods and their embodiments. Specifically, the apparatus includes one or more units configured to perform any one of the above mentioned methods and their embodiments.

According to one aspect of this disclosure, there is provided a computer-readable storage medium. The computer-readable storage medium stores a computer program, and when the computer program is executed by an apparatus, the apparatus is enabled to implement any one of the above mentioned methods and their embodiments.

According to one aspect of this disclosure, there is provided a computer program product including one or more instructions. When the instructions are executed by an apparatus such as a computer, the apparatus is enabled to implement any one of the above mentioned methods and their embodiments.

According to one aspect of this disclosure, there is provided a computer program. When the computer program is executed by a computer, an apparatus is enabled to implement any one of above mentioned methods and their embodiments.

According to one aspect of this disclosure, there is provided a communication system.

The communication system includes a first communication-node and/or a second communication-node, the first communication-node is configured to perform the methods regarding with the STA as stated above, and the second communication-node is configured to perform the methods regarding AP as stated above.

According to one aspect of this disclosure, there is provided an apparatus for implementing the methods in any possible implementation of the foregoing aspects.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 is a schematic illustration of an example communication network, according to implementations of the present disclosure.

FIG. 2 is a schematic illustration of another example communication network, according to implementations of the present disclosure.

FIG. 3 is a schematic illustration of an apparatus wirelessly communicating with another apparatus within a communication system, according to implementations of the present disclosure.

FIG. 4 is a schematic illustration of an example apparatus configured to implement one or more methods disclosed herein, according to implementations of the present disclosure.

FIG. 5 is a schematic illustration of another example apparatus configured to implement one or more methods disclosed herein, according to implementations of the present disclosure.

FIG. 6 is a schematic illustration of AMP STA's example operation energy states, according to prior art.

FIG. 7 is a schematic illustration of a preamble format for the energy signal, according to an implementation of the present disclosure.

FIG. 8 is a schematic illustration of a preamble format for the energy signal, according to another implementation of the present disclosure.

FIG. 9 is a schematic illustration of an AMP frame format, according to an implementation of the present disclosure.

FIG. 10 is a schematic illustration of an AMP frame format, according to another implementation of the present disclosure.

FIG. 11 is a schematic illustration of an AMP ACK frame format, according to an implementation of the present disclosure.

It will be noted that throughout the appended drawings, like features are identified by like reference numerals.

### DETAILED DESCRIPTION

This disclosure is related to the standardization of the next generation IEEE™ 802.11bp standard. This disclosure is applicable to access points (APs) and AMP STAs. Some or all of methods disclosed herein may be incorporated into a future 3GPP™ standard.

The present disclosure sets forth various implementations via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The phrase “in implementations” can be interpreted to mean “in one or more, but not necessarily all implementations.”

This invention pertains to an energy-aware mechanism for AMP STAs to communicate with APs, and for APs to obtain information from AMP STAs, such as an AMP STA's current energy state, by leveraging uplink data packets that are already being transmitted by the AMP STA to communicate the energy level information associated to these packets, thereby minimizing additional overhead. Such leveraging of ongoing transmissions enables the AP to be aware of a current energy state of the AMP STA and enables the AP to make timely, informed, and energy-aware decisions about transmissions to the AMP STA, such as when to send an Acknowledgement (ACK) message to the AMP STA to acknowledge successful reception of the AMP STA's UL physical layer protocol data unit (PPDU). By leveraging implementations disclosed herein, the AP can more effectively schedule ACK transmissions to AMP STAs, limiting situations where the AP initiates an ACK with AMP STAs that lack sufficient power to receive the ACK. Implementations of the present disclosure may lead to significant improvements in network efficiency and to a reduction of wasted resources.

Given that AMP STAs often operate on very limited energy budgets and may take a substantial amount of time to recharge, dedicated and possibly frequent Energy Level status reports can consume valuable energy, potentially leading to faster depletion of AMP STA's energy resources (e.g., battery charge, power level). UL transmissions (e.g., data packets) can be used to provide the AP with energy level information of AMP STAs. Such information can be embedded within existing UL data packets, thereby limiting or eliminating the need for separate or dedicated energy level reporting and further consolidating energy expenditure. Having the information of an AMP STA's energy state, enables the AP to make energy-aware transmission (e.g., ACK transmission) scheduling, reducing the need for potential re-transmissions in cases where the AMP STA cannot receive the (e.g., ACK) transmission due to insufficient energy resources.

In some implementations, the AP may leverage the next AMP Trigger frame that solicits a UL PPDU from the AMP STA to provide an ACK for a previous UL PPDU received from the same AMP STA.

In some implementations, the energy signal that is used to charge the AMP STA may be utilized to provide an ACK for a previous UL PPDU received from the same AMP STA.

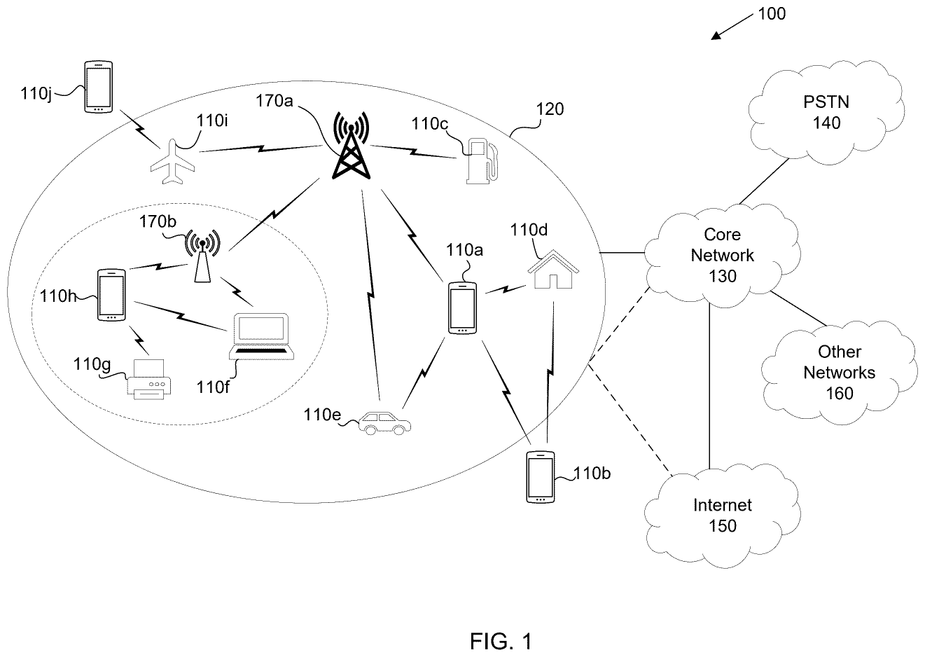

FIG. 1 schematically illustrates a communication network 100, according to implementations of the present disclosure. The communication network 100 may include an underlay network, such as a transport network. The communication network 100 may include an overlay network, such as a mobile network. The communication network 100 may include an application-driven network. The communication network 100 may include a radio access network (RAN) 120. The RAN 120 may be a next generation (e.g., 6th generation (6G) or later) radio access network, or a legacy (e.g., 5th generation (5G), 4th generation (4G), 3rd generation (3G) or 2nd generation (2G)) radio access network. In some implementations, the 6G radio access refers to a next generation air interface of standards which may comprise both terrestrial networks (TNs) and non-terrestrial networks (NTNs). The communication network 100 may include a core network (CN) 130 that may be dependent or independent of the radio access technology used in the network. The communication network 100 may include a public switched telephone network (PSTN) 140, the internet 150, and other networks 160. In general, the communication network 100 enables communication of multiple wireless or wired nodes thereof. One or more nodes 110a, 110b, 110c, 110d, 110e, 110f, 110g, 110h, 110i, 110j may be interconnected to one another and/or connected to one or more network elements 170a, 170b, such as base stations, aquatic stations, aerial stations, or ground stations, in the RAN 120.

The communication network 100 may provide content, such as voice, data, video, and/or text, via broadcast, multicast, groupcast, unicast, etc. The communication network 100 may operate by sharing resources, such as carrier spectrum bandwidth, among its constituent elements. The communication network 100 may provide a wide range of communication services and applications to network users including enhanced Mobile Broadband (eMBB) services, ultra-reliable low-latency communication (URLLC) services, massive machine type communication (mMTC) services, integrated sensing and communication (ISAC), immersive communication, massive communication, Hyper reliable and low-latency communication, ubiquitous connectivity, integrated AI and communication, and other services that can be provided by a future generation communication system. The communication network 100 may provide other services and applications such as earth monitoring, remote sensing, passive sensing and positioning, navigation and tracking, autonomous delivery and mobility, etc.

The communication network 100 may include a terrestrial network and/or a non-terrestrial network. The communication network 100 may provide a high degree of availability and robustness through a joint operation of a terrestrial network and a non-terrestrial network. For example, integrating a non-terrestrial network (or components thereof) into a terrestrial network can result in a heterogeneous network comprising multiple blocks. The heterogeneous network may achieve better overall performance through efficient multi-link joint operation, more flexible functionality sharing, and faster physical block link switching between terrestrial networks and non-terrestrial networks. The terrestrial network and the non-terrestrial network could be considered sub-systems of the communication network 100.

The communication network 100 may be compliant with one or more regional, national and/or international standard, such as the Internet Engineering Task Force (IETF), the European Telecommunications Standards Institute (ETSI™), and the Third Generation Partnership Project (3GPP™).

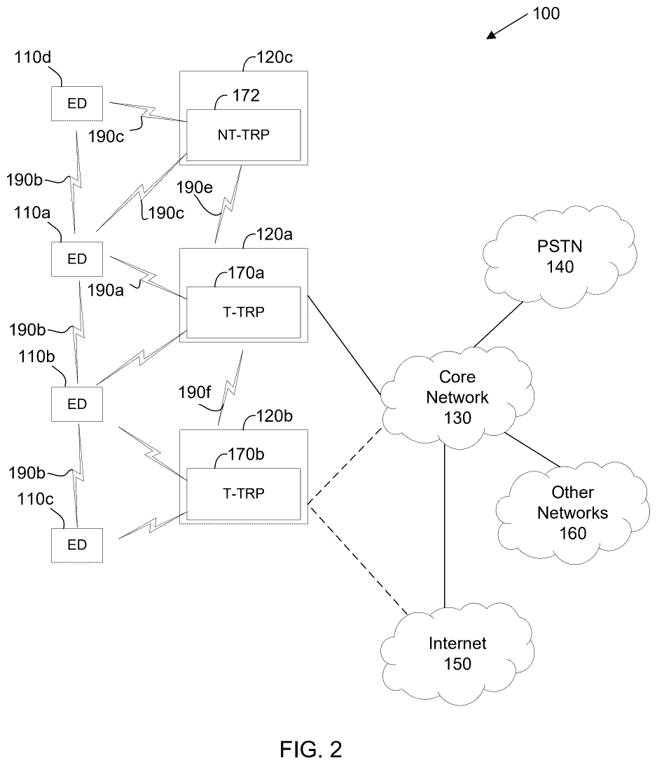

FIG. 2 illustrates another example communication system 100 according to an implementation of the present disclosure. The communication system 100 includes user equipment/electronic devices (UEs/Eds) 110a, 110b, 110c, 110d (collectively referred to as a UE/ED 110, such as AMP STA(s)), RANs 120a, 120b, one or more CNs 130, a PSTN 140, the Internet 150, and other networks 160. Additionally, the communication system 100 may also include a non-terrestrial network (NTN) 120c. The RANs 120a and 120b may include network elements 170a and 170b respectively. Examples of network elements 107a, 107b include base stations, which can be generally referred to as terrestrial network (TN) devices or terrestrial transmit and receive points (T-TRPs) 170a and 170b (collectively referred to as 170). In this context, the terms “TRP” and “base station” are used interchangeably unless otherwise specified. For simplicity, this disclosure primarily refers to network nodes as base stations; however, unless explicitly stated otherwise, references to TRP are considered non-limiting and interchangeable. The T-TRPs 170a, 170b may be base stations mounted on a building or tower. In one implementation, the NTN 120c includes a RAN node such as a base station 172, which may be generally referred to as an NTN device, a non-terrestrial node, a non-terrestrial network device, a non-terrestrial base station, or a non-terrestrial transmit and receive point (NT-TRP) 172.

In some implementations, the NT-TRP 172 is not attached to the ground, for example, as in the case of an airborne base station. An airborne base station may be implemented using communication equipment supported or carried by a flying device. For example, a flying device may include, but is not limited to, an airborne platform (such as a blimp or an airship), balloon, drone (such as quadcopter), and other types of aerial vehicles. In some implementations, an airborne base station may be supported or carried by an unmanned aerial system (UAS) or an unmanned aerial vehicle (UAV), such as a drone. An airborne base station may be a moveable or mobile base station that can be flexibly deployed in different locations to meet network demand.

A satellite base station is another example of a non-terrestrial base station. A satellite base station may be implemented using communication equipment supported or carried by a satellite. A satellite base station may also be referred to as an orbiting base station. High altitude platforms are yet another example of non-terrestrial base stations, including international mobile telecommunication base stations.

As referred to herein, and unless specified otherwise, a “TRP” may also refer to a T-TRP or an NT-TRP, a “T-TRP” may also refer to a “TN TRP”, and an “NT-TRP” may also refer to an “NTN TRP”. The NTN 120c may be considered a RAN, sharing operational aspects with RANs 120a, 120b. The NTN 120c may include at least one NTN device and at least one corresponding terrestrial network device. The at least one NTN device may function as a transport layer device and the at least one corresponding terrestrial network device may function as a RAN node, communicating with the UE/ED 110 via the NTN device. Additionally, there may be an NTN gateway on the ground (referred to as a terrestrial network device) that also functions as a transport layer device facilitating communication with both the NTN device and the RAN node. The RAN node may communicate with the UE/ED 110 via the NTN device and the NTN gateway. In some implementations, the NTN gateway and the RAN node may be located within the same device.

Abase station 170 (also referred to as a TRP as stated above) is a network element within a radio access network responsible for radio transmission and reception in one or more cells to or from the UE/ED (such as a user equipment). In different implementations, the base station 170 may also be known as a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a non-terrestrial node, a non-terrestrial network device, a non-terrestrial base station, and a positioning node, among other possibilities. The base station 170 may be a macro base station (BS), a pico BS, a relay node, a donor node, or combinations thereof. When the base station 170 performs (or is configured to perform) a method described herein, it may be interpreted as the base station itself, one or more modules (or units) in the base station, a circuit or chip, or a combination thereof, performing the method. For example, the circuit or chip may include a modem chip, also referred to as a baseband chip, a system on chip (SoC) including a modem core, system in package (SIP)), and the like, and may be responsible for one or more communication functions within the base station.

The UEs/EDs 110a-110d and TRPs 170a-170b, 172 are examples of communication equipment configured to implement some or all of the operations and/or implementations described herein. The T-TRP 170a forms part of the RAN 120a, which may include other TRPs, and/or other devices. Also, the TRP 170b forms part of the RAN 120b, which may include other TRPs, and/or devices. Each TRP 170a, 170b may transmit and/or receive wireless signals within a particular geographic region or area, sometimes referred to as a “cell” or a “coverage area”. The TRPs 170a-170b may be responsible for allocating and/or configuring resources and transmission and/or reception in a set of cell(s). A cell is a radio network object that can be uniquely identified by a cell identification that is broadcasted over a geographical region or area from base stations associated with the cell. A cell can work in either FDD or TDD mode. A cell may be further divided into cell sectors, and a base station 170a-170b may, for example, employ one or more transceivers to provide services to one or more sectors. Some implementations may include pico or femto cells if supported by the radio access technology. In some implementations, one or more transceivers could be used for each cell, such as with Multiple-Input Multiple-Output (MIMO) technology. The number of RANs 120a-120b shown is merely an example. Any number of RANs may be contemplated when designing the communication system 100.

A base station may be a single element, as shown in the figures, or multiple elements distributed throughout the corresponding RAN, or otherwise configured. In some implementations, a plurality of RAN nodes coordinate to assist the UE/ED 110 in implementing radio access, and different RAN nodes separately implement and handle different functions of the base station. For example, the RAN node may be a central unit (CU), a distributed unit (DU), a CU-control plane (CP), a CU-user plane (UP), or a radio unit (RU) etc. The CU and the DU may be separately deployed, or included within the same element (i.e., a baseband unit (BBU)). The RU may be included in a radio frequency device or a radio frequency unit (i.e., a remote radio unit (RRU), an active antenna unit (AAU), or a remote radio head (RRH)). In different systems, the CU (or the CU-CP and the CU-UP), the DU, or the RU may be known by different names, but their functions are understood by person skilled in the art. For example, in an open radio access network (ORAN) system, a CU may be referred to as an open CU (O-CU), a DU may be referred to as an open DU (O-DU), and a CU-CP may be referred to as an open CU-CP (O-CU-CP). The CU-UP may also be referred to as an open CU-UP (O-CU-UP), and the RU may also be referred to as an open RU (O-RU). Any one of the CU (or the CU-CP, the CU-UP), the DU, and the RU may be implemented using a software module, a hardware module, or a combination of a software module and a hardware module.

Furthermore, communication between different devices/apparatuses in various implementations of this disclosure may refer to direct communication (that is, without the need of forwarding by another device/apparatus), or may refer to communication(s) between different devices/apparatuses via another device/apparatus (that is, requiring forwarding by another device/apparatus). Alternatively, such communication(s) may involve one functional unit inside a device/apparatus using another functional unit within the device/apparatus to communicate with another device/apparatus. In other words, phrases such as “sending (or transmitting) information to . . . (a UE/ED or a base station)” in this disclosure may be understood as a destination endpoint of the information being an ED or a base station, including, sending/transmitting information directly or indirectly to an ED or a base station. Similarly, phrases like “receiving information from . . . (an ED or a base station)” may be understood as a source endpoint of the information being an ED or a base station, including directly or indirectly receiving information from an ED or a base station. Between the source endpoint that sends the information and the destination endpoint, necessary processing such as, but not limited to, format conversion, digital-to-analog conversion, amplification, and filtering may be performed on the information. However, the destination endpoint may understand valid information from the source endpoint. A similar understanding applies to other descriptions in this disclosure without reiterating details already described. In the present disclosure, the terms “send” and “transmit” may be used interchangeably in different implementations of this disclosure.

The UE/ED 110 is used to connect people, objects, machines, and other entities. The UE/ED 110 may be widely used in various scenarios including, but not limited to, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, and autonomous delivery and mobility.

Each UE/ED 110 represents any suitable end user device for wireless operation, such as an AMP STA, and may include such devices (or may be referred to as, but not limited to) a user equipment (UE) or a user device or a terminal device, a wireless transmit/receive unit (WTRU), a mobile station, a fixed or mobile subscriber unit, a cellular telephone, a station (STA), an MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus (such as a module, modem, or chip) in the forgoing devices, among other possibilities. Future generation LEs/EDs 110 may be referred to by other terms. When a UE/ED 110 performs (or is configured to perform) a method described herein, it may be interpreted as the UE/ED itself, one or more modules (or units) in the UE/ED, a circuit or chip, or a combination thereof, performing the method. For example, the circuit or chip may include a modem chip, also referred to as a baseband chip, a system on chip (SoC) including a modem core, or system in package (SIP)), and the like, and may be responsible for one or more communication functions in the UE/ED.

Each UE/ED 110 connected to TRPs 170a-170b, and/or TRPs 172 can be dynamically or semi-statically turned-on (i.e., established, activated, or enabled), turned-off (i.e., released, deactivated, or disabled) and/or configured in response to one of more of: connection availability and connection necessity.

Any UE/ED 110 may be alternatively or additionally configured to interface, access, or communicate with any of the TRPs 170a, 170b and 172, the Internet 150, the CN 130, the PSTN 140, the other networks 160, or any combination thereof. In some examples, the UE/ED 110a may communicate an uplink (UL) and/or downlink (DL) transmission over a terrestrial air interface 190a with station-TRP 170a. In some examples, the UEs/EDs 110a, 110b, 110c, and 110d may also communicate directly with one another via one or more sidelink (SL) air interfaces 190b. In some examples, the UEs/EDs 110a, 110d may communicate using an UL and/or DL transmission over a non-terrestrial air interface 190c with NT-TRP 172.

An air interface (such as, for example, 190a, 190b, 190c) generally includes a number of components and associated parameters that collectively specify how a transmission is to be sent and/or received over a wireless communications link between two or more communicating devices such as UEs/EDs and base station(s). For example, an air interface may include one or more components defining the waveform(s), frame structure(s), multiple access scheme(s), protocol(s), coding scheme(s) and/or modulation scheme(s) for conveying information (such as, data) over a wireless communications link. The air interfaces 190a and 190b may use similar communication technology, that may include any suitable radio access technology.

The non-terrestrial air interface 190c can enable communication between the UEs/EDs 110a, 110d and one or more NT-TRPs 172 via a wireless link or simply a link. For some examples, the link is a dedicated connection for unicast transmission, a connection for broadcast transmission, or a connection between a group of UEs/EDs 110 and one or more NT-TRPs 172 for multicast transmission.

The TRPs 170a-170b, 172 may communicate with one another over one or more air interfaces 190e, 190f using wireless communication links (such as radio frequency (RF), microwave, infrared (IR), etc.) or wired communication links. The air interfaces 190e, 190f may utilize any suitable radio access technology, and may be substantially similar to the air interfaces 190a, 190c over which the UEs/EDs 110a-110d communicate with one or more of the TRP 170a-170b, 172 or they may be substantially different. For example, the communication system 100 may implement one or more channel access methods, such as Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA).

The RANs 120a and 120b are in communication with the CN 130 to provide the UEs/EDs 110a 110b, and 110c with various services such as voice, data, multimedia, and other services. The RANs 120a and 120b and/or the CN 130 may be in direct or indirect communication with one or more other RANs (not shown), which may or may not be directly served by the CN 130, and may employ different radio access technologies from RAN 120a and/or RAN 120b. The CN 130 may also serve as a gateway access between (i) the RANs 120a and 120b and/or the UEs/EDs 110a 110b, and 110c, and (ii) other networks (such as the PSTN 140, the Internet 150, and the other networks 160). In addition, some or all of the UEs/EDs 110a 110b, and 110c may include functionality for communicating with different wireless networks over different wireless links using different wireless technologies and/or protocols. For example, the UEs/EDs 110a 110b, and 110c communicate using different cellular communications protocols, such as, but not limited to, a Global System for Mobile Communications (GSM™) protocol, a code-division multiple access (CDMA) network protocol, a Push-to-Talk (PTT) protocol, a PTT over Cellular (POC) protocol, a Universal Mobile Telecommunications System (UMTS™) protocol, a 3GPP™ Long Term Evolution (LTE™) protocol, a fifth generation (5G) protocol, a New Radio (NR) protocol, and the like. Instead of wireless communication (or in addition thereto), the UEs/EDs 110a 110b, and 110c may communicate using wired communication channels to a service provider or switch (not shown), and/or to the Internet 150. The PSTN 140 may include circuit switched telephone networks for providing plain old telephone service (POTS). The Internet 150 may include a network of computers and subnets (intranets) or both, and incorporate protocols, such as internet protocol (IP), transmission control protocol (TCP), user datagram protocol (UDP). UEs/EDs 111a 110b, and 110c may be multimode devices capable of operation according to multiple radio access technologies, and may incorporate one or multiple transceivers necessary to support such.

In addition, the communication system 100 may comprise a sensing agent (not shown) to manage the sensed data from UE/ED 110 and/or any one of TRPs 170a, 170b, 172. In one implementation, the sensing agent may be part of any one of TRPs 170a, 170b, 172. In another implementation, the sensing agent is a separate node that can communicate with the CN 130 and/or the RAN 120 (such as any one of TRPs 170a, 170b, 172).

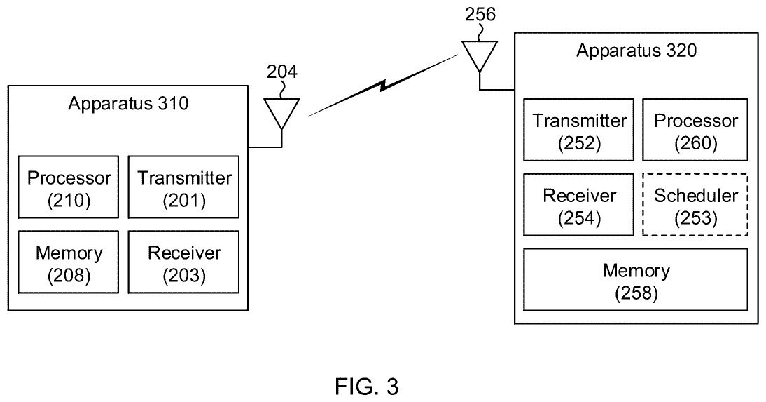

FIG. 3 is a schematic illustration showing an apparatus 310 wirelessly communicating with another apparatus 320 within a communication system (e.g., the communication system 100) according to an implementation of the present disclosure. The apparatus 310 may be an electronic device (such as ED 110, such as an AMP STA). The apparatus 320 may be a network node (e.g., the network node 170, such as an AP) such as T-TRP 170 or an NT-TRP 172. Although only one apparatus 310, and one apparatus 320 are shown in the figure, the number of apparatus 310 and/or number of apparatus 320 can vary, potentially including one or more of each. For example, a single ED 110 may be served by a single T-TRP 170 (or a single NT-TRP 172), or by multiple T-TRPs 170 (or multiple NT-TRPs 172). Similarly, a single ED 110 may be served by one or more T-TRPs 170 and one or more NT-TRPs 172. Similarly, a single T-TRP 170 (or a single NT-TRP 172) may serve one or more EDs 110.

The apparatus 310 may include one or more processors 210. For clarity and to avoid overcrowding the illustration, only a single processor 210 is illustrated. The apparatus 310 may further include a transmitter 201 and a receiver 203 coupled to one or more antennas 204. For clarity, only a single antenna 204 is illustrated. One, some, or all of the antennas 204 may alternatively be panels. In some implementations, the transmitter 201 and the receiver 203 are separate from each other. In other implementations, the transmitter 201 and the receiver 203 may be integrated into a single unit, for example, as a transceiver. The transceiver is configured to modulate data or other content for transmission by the one or more antennas 204 or a network interface controller (NIC). The transceiver may also be configured to demodulate data or other content received by the one or more antennas 204. A transceiver may include any suitable structure for generating signals for wireless or wired transmission and/or for processing signals received through wireless or wired communication. Each antenna 204 includes any suitable structure for transmitting and/or receiving wireless or wired signals. The apparatus 310 may include a memory 208. In some implementations, the apparatus 310 may include multiple memories 208. Only a single transmitter-201, receiver 203, processor 210, memory 208, and antenna 204 is illustrated for simplicity, but the apparatus 310 may include one or more other components. In some implementations of the present disclosure, the transceiver (or transmitter 201 and/or receiver 203) may be viewed as an interface circuit.

The memory 208 is configured to store instructions used to perform operations described herein. The memory 208 may also be configured to store data that is used, generated, or collected by the apparatus 310. For example, the memory 208 can store software instructions or modules configured to implement some or all of the functionalities and/or operations described herein and that which are executed by the one or more processors 210.

The apparatus 310 may further include one or more input/output devices (not shown) or interfaces. The input/output devices or interfaces facilitate interaction with a user or other devices in the network. Each input/output device or interface includes suitable components for facilitating transmission of information to a user and reception of information from a user, and for various network interface communications. Such components may include, but are not limited to, a speaker, microphone, keypad, keyboard, display, touch screen, and the like.

The processor 210 may be configured to perform (or control the apparatus 310 to perform) operations (or methods) described herein as being performed by the apparatus 310. For example, the processor 210 performs or controls the apparatus 310 to perform the operations of: a) receiving one or more transport blocks (TBs), b) using a resource for decoding at least one of the received TBs, c) releasing the resource for decoding another of the received TBs, and/or d) receiving configuration information configuring a resource. Specifically, the operations may include tasks related to: preparing a transmission for UL transmission to the apparatus 320, processing DL transmissions received from the apparatus 320, and handling SL transmission to and from another apparatus 310. Processing operations related to preparing a transmission for UL transmission may include operations such as, but not limited to, encoding, modulating, transmit beamforming, and generating symbols for transmission. Processing operations related to processing DL transmissions may include operations such as, but not limited to, receive beamforming, demodulating and decoding received symbols. Processing operations related to processing SL transmissions may include operations such as, but not limited to, transmit/receive beamforming, modulating/demodulating and encoding/decoding symbols. Depending upon the implementation, a DL transmission may be received by the receiver 203, possibly using receive beamforming, and the processor 210 may extract signaling from the DL transmission (such as by detecting and/or decoding the signaling). An example of signaling may be a reference signal transmitted by the apparatus 320. In some implementations, the processor 210 implements the transmit beamforming and/or the receive beamforming based on the indication of beam direction, such as beam angle information (BAI), received from the apparatus 320. In some implementations, the processor 210 may be configured to perform operations relating to network access (such as initial access) and/or downlink synchronization, which includes operations for detecting a synchronization sequence, decoding and obtaining the system information, and the like. In some implementations, the processor 210 may perform channel estimation, such as using a reference signal received from the apparatus 320.

Although not illustrated, in some implementations, the processor 210 may either be a part of the transmitter 201 or a part of the receiver 203 or a part of both the transmitter 201 and the receiver 203. Although not illustrated, in some implementations, the memory 208 may be a part of the processor 210.

The processor 210, along with the processing components of the transmitter 201 and the receiver 203 may each be implemented by one or more processors that may the same or different. These processors are configured to execute instructions stored in a memory (such as in the memory 208).

The apparatus 320 includes one or more processors 260 (only one processor 260 is illustrated). The apparatus 320 may further include one or more transmitters 252 and one or more receivers 254 coupled to one or more antennas 256. Only a single antenna 256 is illustrated to avoid clutter in the illustration. One, some, or all of the antennas 256 may alternatively be panels. In some implementations, the transmitter 252 and the receiver 254 are separate from each other. In other implementations, the transmitter 252 and the receiver 254 may be integrated into a single unit such as, for example, as a transceiver. The apparatus 320 may further include a memory 258. In some implementations, the apparatus 320 may include multiple memories 258. The apparatus 320 may further include a scheduler 253. Only a single transmitter 252, receiver 254, processor 260, memory 258, antenna 256 and scheduler 253 are illustrated for simplicity, however the apparatus 320 may include one or more other components. In the present disclosure, in some implementations, the transceiver (or transmitter 252 and/or receiver 254) may be viewed as an interface circuit.

In some implementations, various components of the apparatus 320 may be distributed. For example, some of the modules of the apparatus 320 may be located remotely from the equipment housing the antennas 256 for the apparatus 320 (and therefore also can be viewed as one or more nodes). These modules, which can be considered as one or more nodes, may be coupled to the equipment that houses the antennas 256 over a communication link (not shown), sometimes referred to as front haul, such as the Common Public Radio Interface (CPRI). Therefore, in some implementations, the term apparatus 320 may also refer to network-side nodes that perform processing operations such as, but not limited to, determining the location of the apparatus 310, resource allocation (scheduling), message generation, and encoding/decoding, and that which are not necessarily part of the equipment that houses the antennas 256 of the apparatus 320. The nodes may also be coupled to other apparatuses 320. In some implementations, the apparatus 320 may actually be a plurality of nodes that are operating together to serve the apparatus 310, such as through the use of coordinated multipoint transmissions, or through the use of ORAN system as described above in the disclosure.

The processor 260 is configured to perform operations including those related to: preparing a transmission for DL transmission to the apparatus 310, processing an UL transmission received from the apparatus 310, preparing a transmission for backhaul transmission to another apparatus 320, and processing a transmission received over backhaul from another apparatus 320. Processing operations related to preparing a transmission for DL or backhaul transmission may include operations such as, but not limited to, encoding, modulating, precoding (such as MIMO precoding), transmit beamforming, and generating symbols for transmission. Processing operations related to processing received transmissions in the UL or over backhaul may include operations such as, but not limited to, receive beamforming, demodulating received symbols, and decoding received symbols. The processor 260 may also be configured to perform operations relating to network access (such as initial access) and/or DL synchronization, such as generating the content of synchronization signal blocks (SSBs), generating the system information, and the like. In some implementations, the processor 260 is further configured to generate an indication of beam direction, such as BAI, which may be scheduled for transmission by the scheduler 253 which will be described below. In some implementations, the processor 260 implements the transmit beamforming and/or receive beamforming based on beam direction information (such as BAI) received from another apparatus 320. The processor 260 is configured to perform other network side processing operations described herein, such as, but not limited to, determining the location of the apparatus 310, determining where to deploy another apparatus 320, and the like. In some implementations, the processor 260 may generate signaling data, to configure one or more parameters of the apparatus 310 and/or one or more parameters of another apparatus 320. Any signaling data generated by the processor 260 is sent by the transmitter 252. In some implementations, the apparatus 320 implements physical layer processing. In some implementations, the apparatus 320 may perform higher layer functions such as those at the Medium Access Control (MAC) or Radio Link Control (RLC) layers in addition to physical layer processing. In the apparatus 320, the scheduler 253 may be coupled to the processor 260 or integrated within the processor 260. In some implementations, the scheduler 253 may be integrated within the apparatus 320 or may be operated separately from the apparatus 320. The scheduler 253 may schedule UL, DL, SL, and/or backhaul transmissions, including issuing scheduling grants and/or configuring scheduling-free (such as “configured grant”) resources.

The apparatus 320 may further include a memory 258 that is configured to store instructions for performing the operations described herein. The memory 258 may also store data that is used, generated, or collected by the apparatus 320. For example, the memory 258 can store software instructions or modules configured to implement some or all of the functionalities and/or implementations described herein and that which are executed by the processor 260.

Although not illustrated, the processor 260 may be implemented as part of the transmitter 252 and/or a part of the receiver 254. Although not illustrated, in some implementations, the processor 260 may implement the scheduler 253 and the memory 258 may be implemented as part of the processor 260.

The processor 260, the scheduler 253, the processing components of the transmitter 252, and the processing components of the receiver 254 may each be implemented by the same or different processors that are configured to execute instructions stored in a memory, such as in the memory 258.

The apparatus 320 and/or the apparatus 310 may include other components, not shown or described herein for the sake of clarity.

Note that the term “signaling”, as used herein, may alternatively be referred to as control signaling, control message, control information, or message for simplicity. Signaling between a base station (such as the TRP 170a. 170b, 172) and a UE or sensing device (such as ED 110), or signaling between a different UE or sensing device (such as between ED 111a and ED 110b) may be carried in physical layer signaling (also called as dynamic signaling), which is transmitted in a physical layer control channel. For DL, the physical layer signaling may be known as downlink control information (DCI) which is transmitted in a physical downlink control channel (PDCCH). For UL, the physical layer signaling may be known as uplink control information (UCI) which is transmitted in a physical uplink control channel (PUCCH). For SL, signaling between different UEs or sensing devices (such as between ED 110a and ED 110b) may be known as SL control information (SCI) which is transmitted in a physical sidelink control channel (PSCCH). Signaling may be carried in a higher layer (such as higher than physical layer) signaling, which is transmitted in a physical layer data channel, such as in a physical downlink shared channel (PDSCH) for downlink signaling, in a physical uplink shared channel (PUSCH) for uplink signaling, and in a physical sidelink shared channel (PSSCH) for SL signaling. Higher layer signaling may also be called static signaling, or semi-static signaling. The higher layer signaling may include radio resource control (RRC) protocol signaling or media access control-control element (MAC-CE) signaling. Signaling may be included in a combination of physical layer signaling and higher layer signaling.

It should be noted that in the present disclosure, “information”, when different from “message”, may be carried within a single message, or may be carried in multiple separate messages.

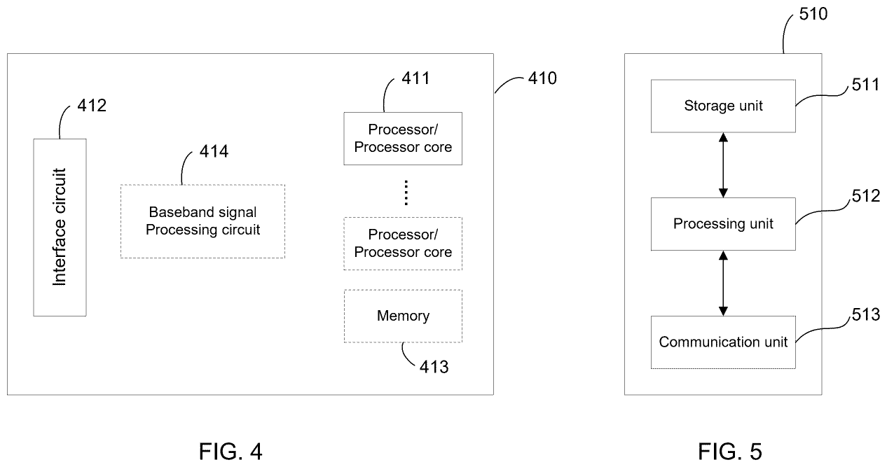

FIG. 4 illustrates an example apparatus 410 according to an implementation of the present disclosure. The apparatus 410 may be a communication device or an apparatus implemented in a communication device such as the ED 110 or the TRPs 170a, 170b, 172. For example, the apparatus 410 implemented in an ED, such as an AMP STA or an AP, may be an integrated circuit, which in some instances may be referred to as a chip, a modern, a modem chip, a baseband chip, or a baseband processor. In some implementations, one or more integrated circuits can be packaged into a system-on-chip, a system-in-package, or a multi-chip module. The apparatus 410 can include one or more integrated circuits and other discrete components. In some implementations, the apparatus 410 may be a module within the ED 110, or within the apparatus 310. In some implementations, the apparatus 410 may be a module within one of the TRPs 170a, 170b, 172, or the apparatus 320.

In an example, the apparatus 410 may include one or more processors 411, and an interface circuit 412. The apparatus 410 may further include a memory 413. The one or more processors 411 are configured to process signals and execute one or more communication protocols. The memory 413 is configured to store at least a part of corresponding computer program instructions and/or data. In an example, the one or more processors 411 execute the computer program instructions stored in the memory 413 to implement related operations (for example, inputting, outputting, receiving, and transmitting) in the method implementations disclosed herein. In some implementations, the memory 413 being configured to store the corresponding computer program instructions and/or data may mean that the memory 413 is configured to store all of the corresponding computer program instructions and/or data for execution by the one or more processors 411. In some implementations, the memory 413 being configured to store the corresponding computer program instructions and/or data may mean that the memory 413 is configured to store a part of the corresponding computer program instructions and/or data. For example, the part of the corresponding computer program instructions and/or data may include computer program instructions and/or data that need to be currently executed by the one or more processors 411. Thus, the memory 413 may store different parts of computer program instructions and/or data for a plurality times for the one or more processors 411 to perform related operations in the method implementations disclosed herein. As a communication interface, the interface circuit 412 is configured to implement communication with another component. For example, the interface circuit 412 may communicate a signal with other apparatus/system such as a radio frequency processing apparatus, or processor system. The communication includes transmitting signal (or data, information) to another component or device, or receives signal from another component or device. “transmitting” includes outputting the signal to a component or device that is directly or indirectly coupled to the interface circuit (transmitting unit). “receiving” includes inputting or obtaining a signal from a component or device that is directly or indirectly couped to the interface circuit (receiving unit). Optionally, to reduce a load of the one or more processors, a baseband signal processing circuit 414 may be also disposed to implement processing of at least a part of baseband signals, including signal demodulation, modulation, encoding, decoding, or the like.

The apparatus 410 may be the processor 210 (or 260) within the apparatus 310 (or 320), in some scenarios, or may be included within the processor 210 (or 260) within the apparatus 310 (or 320) in some scenarios. The apparatus 410 may be a baseband chip or may include a baseband chip. In some implementations, the apparatus 410 may be independently packaged into a chip. In some implementations, the apparatus 310 (or 320) includes different types of chips. The apparatus 410 may be packaged into a processor chip (for example, an SoC chip or an SIP chip) with the different types of chips. In some implementations, the apparatus 410 may be packaged into a chip with some or all of circuits of a radio frequency processing system that may further be included in the apparatus 310 (or 320).

FIG. 5 illustrates example apparatus 510 according to an implementation of the present disclosure. The apparatus 510 may include corresponding modules or units configured to implement methods and/or implementations described herein. In some implementations, the apparatus 510 includes a processing unit 512 and a communication unit 513. Optionally, the apparatus 510 may further include a storage unit 511 configured to store apparatus program code (or instructions) and/or data.

The apparatus 510 may be an ED side apparatus, for example, an ED or a module in an ED that is an AMP STA or an AP, or a circuit or a chip responsible for a communication function in an ED that is an AMP STA or an AP. In some implementations, apparatus 510 may be the apparatus 310. The processing unit 512 may be the processor 210. The communication unit 513 may comprise a receiving unit and/or a transmitting unit. The receiving unit and/or the transmitting unit may be the transmitter 201 and/or the receiver 203 respectively. The storage unit 511 may be the memory 208.

The apparatus 510 may be a base station side apparatus, for example, a base station or a module in a base station, or a circuit or a chip responsible for a communication function in a base station. In some implementations, apparatus 510 may be apparatus 320. The processing unit 512 may be the processor 260 (the scheduler 253 may also be included). The communication unit 513 may comprise a receiving unit and/or a transmitting unit. The receiving unit and/or the transmitting unit may be the transmitter 252 and/or the receiver 254 respectively. The storage unit 511 may be the memory 258.

In some implementations, when the apparatus 510 is an ED 110 or a module in an ED 110, a function of the apparatus 510 may be implemented by one or more processors. Specifically, the processor may include a modem chip, or a system on chip (SoC) chip or an SIP chip that includes a modem core. A function of the communication unit 513 may be implemented by a transceiver circuit.

In some implementations, when the apparatus 510 is a circuit or a chip that is responsible for a communication function in an ED 110,—such as a modem chip, a system on chip (SoC) chip or an SIP chip that includes a modem core—a function of the processing unit 512 may be implemented by a circuit system within the chip which includes one or more processors. A function of the communication unit 513 may be implemented by an interface circuit or a data transceiver circuit on the chip.

It may be understood that the units in the apparatus 510 may be logical or functional. Each function may correspond to one functional unit, or two or more functions may be integrated into a single functional unit. In actual implementation, all or some of the units may be integrated into a single physical entity or may be distributed across different physical entities. In addition, the functional units may be implemented in the form of hardware, software, or a combination of hardware and software. Whether a function is implemented in the form of hardware or software depends on particular applications and design constraint conditions of the technical solutions. A person skilled in the art may use different methods to implement the described functions for specific applications, but it should not be considered that the implementation goes beyond the scope of this disclosure.

In an example, a functional unit in any one of the apparatuses may be configured as one or more integrated circuits for implementing the methods disclosed herein, for example, as one or more application-specific integrated circuits (application-specific integrated circuits, ASICs), one or more central processing units (CPUs), one or more microprocessors or microprocessor units (MPUs), one or more microcontrollers or microcontroller units (MCUs), one or more digital signal processors (DSPs), one or more field programmable gate arrays (FPGAs), or a combination of these.

In an example, the storage unit 511 may include a random access memory, a flash memory, a read-only memory, a programmable read-only memory, an electrically erasable programmable memory, and/or a register.

A processor may be referred to as a processor system, an application processor, a baseband processor, a processor circuit, or a processor core. The processor may include one or a combination of one or more central processing units (CPUs), one or more digital signal processors (DSPs), one or more microprocessors (microprocessor units, MPUs), one or more microcontrollers (microcontroller units, MCUs), one or more graphics processing units (GPUs), one or more field programmable gate arrays (FPGAs), one or more artificial intelligence processors (AI processors), or one or more neural network processing units (NPUs).

Memory or a storage unit may include one or more of the following storage media: a random access memory (RAM), a static random access memory (static RAM, SRAM), a dynamic random access memory (dynamic RAM, DRAM), a phase-change memory (PCM), a resistive random access memory (resistive RAM, ReRAM), a magnetoresistive random access memory (magnetoresistive RAM, MRAM), a ferroelectric random access memory (ferroelectric RAM, FRAM/), a cache, a register, a read-only memory (ROM), a flash memory (flash memory), an erasable programmable read-only memory (erasable programmable ROM, EPROM), a hard disk, and the like. In an example, computer program instructions used to execute implementations may be stored in a non-volatile memory, for example, at least a part of a memory or storage unit (for example, one or more of a ROM, a flash memory, an EPROM, or a hard disk). When a terminal runs, a part or all of corresponding computer program instructions may be loaded to a memory that has a higher transmission speed with the processor, for example, at least a part of a memory or a storage unit (for example, one or more of a RAM, an SRAM, a DRAM, a PCM, a RERAM, an MRAM, a FRAM, a cache, or a register), so that the processor executes the computer program instructions to perform the steps in the method implementations disclosed herein.

An AP coordinating with AMP STAs, also referred to herein as AMP devices, might lack information about or indicative of the AMP STA's current energy state. As a result, the AP may initiate a DL transmission to the AMP STA, such as data or ACK, unaware that the AMP STA's energy state is below a threshold level that would be sufficient to receive such DL, which can lead to wasted network resources and transmission failures since the AP spends its resources and energy preparing and transmitting the data or ACK to an AMP STA is unable to receive it and, therefore, the AP may need to repeat the same transmission.

Current communication protocols between an AP and AMP STAs lack a reliable mechanism for AMP STAs to report their energy state. This poses several technical challenges, such as uninformed network management as a result of the AP being unable to make informed decisions about DL data and ACK transmission due to a lack of knowledge or information regarding the AMP STA's current energy state. Network resources may be wasted or inefficiently utilized as a result of the AP transmitting data packets, ACK messages, etc., to an AMP STA with an energy level below a predetermined threshold for receiving, and in some cases processing (e.g., decoding), such DL transmissions. If the AP is unaware of the AMP STA's low energy level (e.g., below a threshold), then the AP's ACK transmissions might fail, leading to unreliability in packet delivery acknowledgment. Such limitations highlight the benefits of novel and robust methods for AMP STAs to report their current energy level to the network, which would advantageously enable the AP to make informed decisions about data transmission, ultimately improving network efficiency and reducing wasted resources.

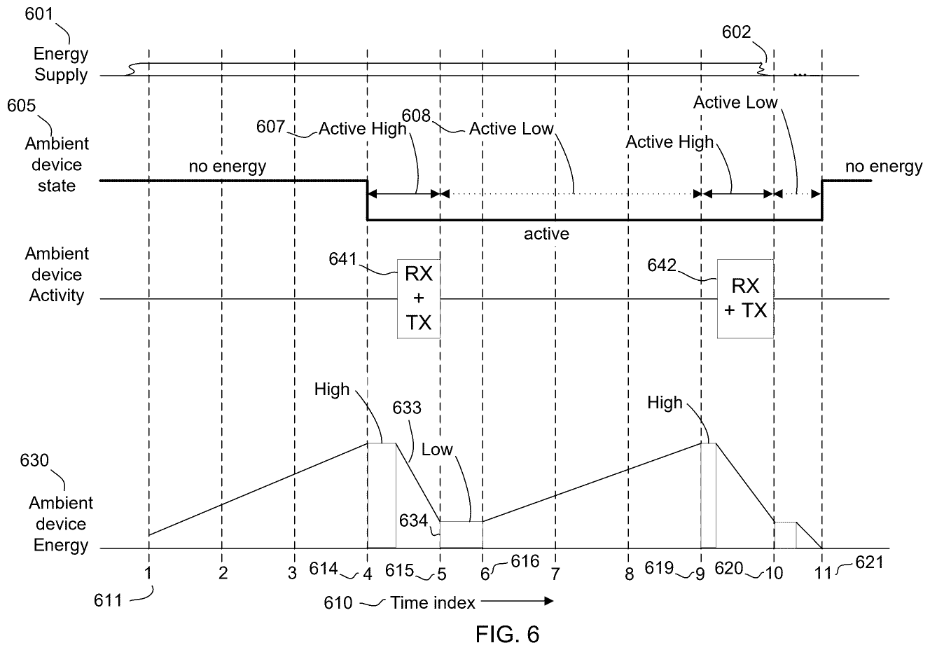

In prior art, the operation energy levels or states 605 of an AMP STA have been defined as shown in FIG. 6.

With reference to FIG. 6, the energy source generates a supply of energy 601 over time T 610, and the AMP STA uses it to harvest and accumulate the energy and refill or recharge its energy level 630. The AMP STA cannot transmit or receive transmissions until its energy becomes high (e.g., see time period ranging from time index of 1 611 to 4 614, in FIG. 6). Once the AMP STA's energy state 605 reaches a high energy state value (e.g., according to a corresponding threshold value, first Active High state 607 reached at time index of 4 614), then the AMP STA may be ready for transmitting or receiving data (e.g., first TX+RX 641).

As transmissions to and from the AMP STA, such as the first TX+RX 641, consume the AMP STA's energy (e.g., first decrease 633 in energy level 630), the AMP STA's energy state 633 reaches a low energy state value 634 (e.g., according to a corresponding threshold) during the time period spanning the time index of 5 615 to the time index 6 616. Even at such a low energy state value 634, the AMP STA may be able to perform some functions, such as taking measurements, storing information, receiving some transmissions, etc. Such a low energy state value can be defined as the Active Low energy state 608. After being at the Active low energy state 608, in order to transmit and receive subsequent transmissions, such as the second RX+TX 642, the AMP STA needs to further harvest and accumulate energy (e.g., during a time period from time index 6 616 to 9 619 in FIG. 6). In the absence of a sufficient supply of energy (e.g., energy supply 301 is unavailable 602 from a time just before time index 10 620), the AMP STA reaches a substantially zero energy state due to exhaustion of energy at time index of 11 621 in FIG. 6.

The AMP STA's current energy state is contingent on the amount of energy it has accumulated (and used up or expended) up to the current time value. When the energy state is low or substantially zero, the AMP STA can accumulate more energy to increase its energy state to an operational level. When the AMP STA is in the Active High energy state (e.g., beginning at time index of 4 614 and 9 619 in FIG. 6), it can perform any action (e.g., transmit, receive, store, process, encode, decode, save, etc.) for which the energy of the Active High energy state is sufficient. In the Active Low energy state, the AMP STA can perform actions that consume less energy, such as memory retention, sensing, and receiving.

More generally, the AMP STA may require some time to accumulate energy and increase its energy level to perform actions that require the AMP STA to have the Active High energy state. After performing such actions, the AMP STA's ability to support the Active Low energy state is uncertain and depends on the energy cost of pending actions and the energy level of the Active Low energy state, on the configuration of the AMP STA, or a combination thereof. Some AMP STAs may not support the Active Low energy state, while others may support the Active Low energy state depending on some predefined circumstances. For example, the actions during the Active High energy state might substantially deplete all the accumulated energy, leaving no energy for the actions that would otherwise be possible during the Active Low energy state.

Implementations disclosed herein pertain to methods for AMP STAs to report their current energy level to the AP(s) in a wireless network, such as a wireless local area network (WLAN), addressing several critical limitations of current wireless communication protocols for AMP STAs noted herein. The current energy level being reported by the AMP STA may be the energy level at the time of reporting, or immediately preceding the time of reporting. The current energy level being reported by the AMP STA may be the energy level the AMP STA will have after transmitting the current transmission, such an UL PPDU, that includes an Energy Level Status indication, as disclosed herein using example embodiments. In other words, the current energy level being reported may take into account the energy to be expended by the AMP STA to transmit the current transmission that includes the Energy Level Status indication, and therefore, may be indicative of the AMP STA's energy level remaining after such transmission.

In implementations, the AP can receive information indicative of the AMP STA's current energy level, such as the current energy state at the time at which the AMP STA prepares such information to be provided, at the time just preceding the time at which the AMP STA prepares such information to be provided, or at the time immediately following the AMP STA preparing and providing such information (i.e., information is indicative of the AMP STA's energy level remaining after preparing and providing information indicative of its current energy level to the AP). Knowing the AMP STA's current energy state enables the AP to avoid spending network resources on transmissions that have a low probability of being successfully received (which may result in potential loss of data) by avoiding transmitting data to AMP STAs that have insufficient energy (e.g., are at or near Active Low energy state, another predefined low energy state, near zero energy state). Knowing the AMP STA's current energy state enables the AP to optimize data scheduling, for example by scheduling data transmissions strategically, such as only when the AMP STA has enough energy to process them (e.g., is at the Active High energy state, at the Active Low energy state, or another predefined energy state). Notably, the Active Low energy state may be sufficient to receive some transmissions that require less energy, but insufficient for receiving other transmissions that require more energy. Knowing the AMP STA's current energy state enables the AP to limit ACK retransmissions, for example by transmitting the ACK transmissions only when a sufficient energy state of the AMP STA has been indicated. Knowing the AMP STA's current energy level contributes to the AP's capability to optimize the timing for sending, or facilitating the sending of, an energy signal to recharge the AMP STA. If the AP and an energizer device configured to provide energy signals to AMP devices are not co-located, the AP can trigger the energizer device to begin transmitting the energy signal(s) to charge the AMP STA at the appropriate time. Additionally, the proposed methods can contribute to limiting the overhead associated with energy reporting transmissions from the AMP STAs through leveraging the DL data packets, and limiting the overhead associated with ACK transmissions from the AP through leveraging the AMP Trigger frame or energy signal, contributing to reduced overall energy use in the network.

In an implementation, instead of (or in addition to) sending dedicated (e.g., standalone) energy level status reports, the AMP STA may include its energy level status information within its uplink data packets (e.g., UL PPDUs) or any other uplink frames (e.g., (re)association or probe response frame, trigger-based (TB) PPDUs, etc.) that the AMP STA transmits to its associated AP. In a non-limiting example, the data of the UL data packets may be data based on sensor readings. Such leveraging of the UL transmissions may reduce the need for AMP STAs to consume additional energy for transmitting dedicated energy level status reports. This may contribute to extending the operational time frame for a given energy state of the AMP STA and the overall operational lifespan of AMVP STAs since less frequent recharging of the AMP STA's energy level may be needed when limiting the energy consumption for control communications. Additionally, leveraging the DL transmissions reduces the need for additional network traffic or scheduling for dedicated energy level status reporting, leading to lower communication overhead and improved efficiency.

In an example implementation, the Energy Level Status indication can be included as a single bit indication (Energy Level Status bit) within the AMP STA's Uplink transmission, for example such that a value of 0 for the single bit indicates a high energy level (e.g., the Active High or not critical energy state, another predetermined high energy state level), and a value of 1 for the single bit indicates a low energy level (e.g., the Active Low energy state, near zero or critical energy state, another predetermined low energy state), or vice versa.

The AMP STA may be configured to form a UL PPDU that includes a one-bit Energy Level Status indication for a current energy level of the AMP STA, and transmit the UL PPDU to the AP.

In an example implementation, the one-bit Energy Level Status indication for the AMP STA may be located within the MAC Header of AMP frame, for example within the MAC Control field of the uplink AMP frame.

In an example implementation, the one-bit Energy Level Status indication for the AMP STA may be located within the MAC Header of AMP frame, for example within the Type-Dependent Control field of the uplink AMP frame.

In an example implementation, the one-bit Energy Level Status indication for the AMP STA may be located within the Frame Body field of the uplink AMP frame.

In an example implementation, the one-bit Energy Level Status indication for the AMP STA may be located within the Type-Dependent Control field of the Frame Body field of the uplink AMP frame.

In an implementation, the AP may continuously monitor (e.g., decode, check the allocated bit) the energy level status of the AMP STA, which is indicated by a one-bit field embedded (leveraged) in the AMP STA's regular UL transmissions such as Data PPDUs or TB-PPDUs. Knowing the energy level status of the AMP STA based on the one-bit indication (Energy Level Status bit), enables the AP to make timely and energy-aware decisions about planned or future transmissions to the AMP STA, for example scheduling when to send an ACK (also referred to herein as ACK Status indication) to acknowledge successful reception of the AMP STA's UL PPDU.

For example, a value of 0 of the Energy Level Status bit can correspond to the High or non-critical energy level, indicating to the AP that the AMP STA has sufficient energy to remain active and perform one or more receive (RX) or/and transmit (TX) operations. In such cases, the AP may immediately transmit the ACK, ensuring reliable and timely communication without risking data retransmission. Notably, the AMP STA that transmits the UL transmission that includes such a one-bit indication of its High energy level can anticipate to receive the ACK substantially immediately after this UL transmission.

Similarly, a value of 1 of the Energy Level Status bit can correspond to Low or critical energy level, indicating to the AP that the AMP STA is at or near energy depletion and is unlikely to remain awake or sufficiently active to receive and decode any incoming DL transmission. In such case, the AP can defer sending the ACK until a more suitable moment (e.g., until a predetermined amount of time according to a typical rate of energy replenishment for the AMP STA, or until the AP receives another UL transmission form the AMP STA that indicates a High energy level), thereby avoiding wasted transmissions and limiting the possibility of the AMP STA failing to receive the ACK transmission. Notably, the AMP STA that transmits the UL transmission or L PPDU that includes such one-bit indication of its Low or critical energy level does not expect to receive a substantially immediate ACK and may, for example, enter an energy harvesting mode until it replenishes sufficient energy.

In an implementation, the AP receives an UL PPDU from the AMP STA that includes an Energy Level Status indication for the AMP STA that indicates a Low or critical energy level, and the AP may delay transmitting a message, such as an ACK for having received the UL PPDU, to the AMP STA.

Some data types that an AMP STA may send to an AP may need acknowledgment (ACK) to ensure reliable delivery, possibly prompting the IoT device (STA) to retain this data in its memory until the ACK is received. Such data types include, for example, data fragmented across multiple frames, especially if the data size is large and is fragmented across multiple packets (or segments), then each fragment may need to be acknowledged by the AP to ensure that the entire data set was received successfully by the AP. In such case, the AMP STA would need to retain each fragment until all ACKs are received. Such example data types include Control Commands and Configuration Data, such as Device Settings and changes to the device's operational parameters (e.g., sampling rate, reporting frequency, thresholds). Other examples of such data types include Commands initiating a firmware update process; Security Credentials, including updates to Wi-Fi® passwords, encryption keys, or authentication tokens; Instructions to trigger an action (e.g., turn on/off a light, lock/unlock a door); Critical Sensor Readings and Event Data (e.g., intrusion detection, fire alarm, critical temperature readings in industrial settings); Transactional Data, such as in applications like smart vending machines or point-of-sale systems, records of transactions (e.g., purchase amount, item dispensed); Critical Telemetry; Buffered Data Requiring Ordered Delivery, such as sequenced sensor readings, especially if the order of sensor readings is crucial for analysis (e.g., tracking movement or a process over time), the AMP STA might buffer a series of readings and require acknowledgment of their successful and ordered delivery; and Log Data.

In an example implementation, the AP may delay transmitting the ACK to the AMP STA and leverage the next AMP Trigger frame that solicits a next UL PPDU from the same AMP STA. For example, a one-bit ACK Status field may be embedded or allocated in the frame body, e.g., in the STA Info field, of the AMP Trigger frame, providing an energy-consuming yet effective way to deliver the ACK to the AMP STA. For example, a value of 0 of the ACK Status field bit can be indicative that the previously solicited or unsolicited transmitted UL PPDU from the AMP STA was not received successfully, which may additionally and automatically indicate to the AMP STA that a retransmission of the previous UL PPDU is being requested. Similarly, a value of 1 of the ACK Status field bit can be indicative that the previously solicited UL PPDU was received successfully by the AP, and may additionally and automatically indicate to the AMP STA that a subsequent or next UL PPDU is being solicited or requested and can be transmitted by the AMP STA to the AP. In addition to the ACK status bit, the fragment number or segment number of the acknowledged or unsuccessfully received packet could also be included in the frame body of the AMP Trigger frame, especially if data fragmentation or segmentation is supported.

In an implementation, the AP may transmit the ACK Status indication to the AMP STA using a dedicated AMP ACK frame.

In some implementations, the AP may leverage an AMP frame to include the ACK Status indication for the AMP STA. Such AMP frame may be an AMP Trigger frame (e.g., soliciting a subsequent UL PPDU from the AMP STA), an AMP Trigger frame scheduling a DL PPDU for the AMP STA, an AMP Beacon frame, an AMP Data frame (e.g., a DL PPDU), or another AMP type frame that may not typically be used for transmitting ACKs but can be configured to carry a one-bit ACK Status indication as disclosed herein by way of example implementations.

In implementations, leveraging the next AMP Trigger frame that solicits UL PPDU from the previously scheduled AMP STA(s) to deliver the ACK for the previous UL PPDU tray be used as a default setting (e.g., at all times), even if the AMP STA has enough energy (e.g., Energy Level Status indication for the AMP STA that indicates a High or non-critical energy level) to receive an immediate ACK, to advantageously limit the overall number of transmissions in the network. Such leveraging can conserve the AMP STA's energy since the AMP STA can save the resources that would otherwise be allocated to receive the dedicated ACK, contributing to optimizing energy usage.

In an example implementation, the AP may delay transmitting the ACK to the AMP STA and leverage an energy signal transmitted to the same AMP STA, for charging the AMP STA or increasing its energy level. The energy signal may be transmitted either by the AP or by an energizer device configured to provide the energy signal to various devices in the network and to deliver the ACK to the AMP STA. For example, a one-bit ACK Status field may be allocated to or embedded within the preamble of the energy signal, which the AMP STA can decode to obtain the ACK status while harvesting the energy of the energy signal to increase its energy level.

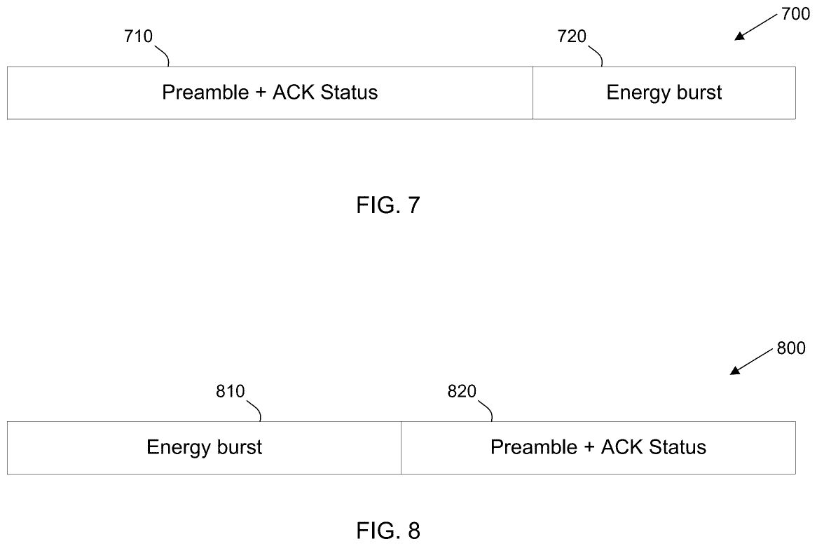

One example format 700 for the energy signal transmitted by the AP or the energizer device to charge the AMP STA is as shown in FIG. 7 and includes a Preamble with ACK Status 710 followed by the Energy burst 720.

Another example format 800 for the energy signal transmitted by the AP or the energizer device to charge the AMP STA is as shown in FIG. 8 and includes the Energy burst 810 followed by the Preamble with ACK Status 820.

Within the energy signal, the value of 0 of the ACK Status indication bit can be indicative that the previously solicited UL PPDU from the AMP STA was not received successfully, which may additionally and automatically indicate to the AMP STA that a retransmission of the previous UL PPDU is being requested. Similarly, a value of 1 of the ACK Status indication bit within the Energy Signal can be indicative that the previously solicited or unsolicited UL PPDU was received successfully by the AP, and may additionally and automatically indicate to the AMP STA that a subsequent or next UL PPDU is being solicited and can be transmitted by the AMP STA to the AP. In implementations, if the energizer device is a standalone device (i.e., separate from the AP), the AP can send the ACK status indication to the corresponding energizer device. The energizer device can be configured to encode the ACK Status bit into its next energy signal directed towards the AMP STA. Notably, the AMP STA may need to be configured to allocate and to retain minimal residual energy to perform decode the ACK Status bit from the energy signal.

In another embodiment, the AP may delay sending the ACK to the AMP STA until after transmitting an energy signal to the same AMP STA in order to charge it or boost its energy level. The energy signal can be sent either by the AP or by an (external to the AP) energizer device that is configured to provide energy to various devices within the network. Once the energy signal is transmitted, the AP may send the ACK, for example as an AMP ACK frame, to the AMP STA. In some implementations, if the energizer device is separate from the AP (i.e., a standalone device), the AP can trigger it, for example by transmitting a corresponding frame, to send the energy signal to the AMP STA, after which the AP will send the ACK, such as an AMP ACK frame.

In an example implementation, to ensure that the AMP STA can receive the ACK Status indication following its UL PPDU transmission, the AMP STA may be configured to transmit the UL PPDU only if the AMP STA has sufficient energy remaining to complete the UL PPDU transmission and receive any immediate response (e.g., the ACK Status, a dedicated ACK, etc.) from the AP following the completed transmission of the UL PPDU. If the AMP STA determines that its current or remaining energy level is insufficient to complete the UL PPDU transmission and receive a subsequent response message from the AP (such as an ACK), then the AMP STA can delay transmitting the UL PPDU even though the remaining energy may be sufficient to complete the UP PPDU transmission alone.

Implementations of AMP frame formats are provided herein. The AMP frames may be used by the AP, for example, to transmit, to the AMP STA, its AMP beacon, to transmit the AMP trigger, to transmit (e.g., dedicated) ACK, AMP Data and other frames to manage and/or control AMP STA(s). Additionally, AMP frames can be used by the AMP STAs to transmit their UL Data PPDUs.

In some implementations, the AMP frames may utilize a format similar to the Wake-up Radio receivers (WUR) frame formats as defined in IEEE™ 802.11ba standard, for example.

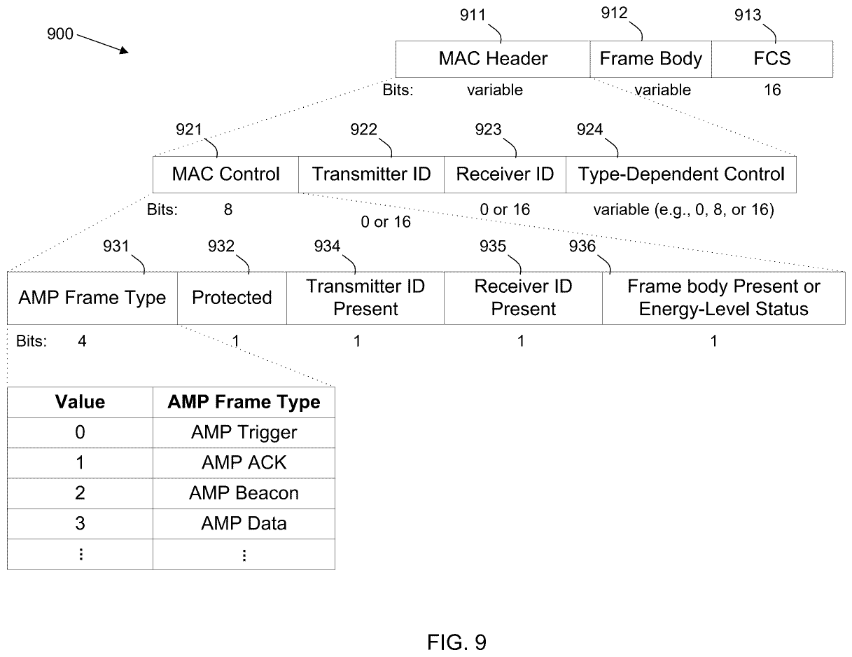

FIG. 9 shows a block diagram of an AMP frame format 900, according to an implementation of the present disclosure. The AMP frame may include a MAC Header 911 having a variable length, a Frame Body 912 having a variable length, and an FCS field 913 having 16 bits. In an implementation, the MAC Header field 911 may include one or more of the following: a MAC Control subfield 921 having 8 bits; a Transmitter ID subfield 922 having 0, 12, or 16 bits; Receiver ID subfield 923 having 0, 12, or 16 bits; Type Dependent Control subfield 924 having 0, 8, 12, or 16 bits; Frame Body Length subfield (not shown) having 0, 4, or 8 bits, and Other TBD subfield(s) (not shown). The MAC Control subfield 921 may include one or more of the following: AMP Frame Type subfield 931 having 3 or 4 bits assigned for example as shown in Table I (notably, the order of the AMP frame types is an illustrative example only, and may be adjusted); Protected subfield 932 having 1 bit (the FCS field contains a 16-bit CRC when the Protected subfield in the Frame Control field is 0, and contains a 16-bit MIC when the Protected subfield in the Frame Control field is set to 1); Transmitter ID Present subfield 934 having 1 bit; Receiver ID Present subfield 935 having 1 bit; Frame Body Present or Energy Level status subfield 936 having 1 bit; Type-Dependent Control Present subfield (not shown) having 1 bit, and/or (e.g., a distinct) Energy Level Status subfield (not shown) having 1 bit to indicate the energy level status of the AMP STA.

TABLE 1
Example value assignments for the AMP Frame Type subfield

| Value | AMP Frame Type |
|---|---|
| 0 | AMP Trigger |
| 1 | AMP ACK |
| 2 | AMP Data or Uplink |
| 3 | AMP Beacon |
| . . . | . . . |

In an implementation, the format for the AMP Trigger frame that can be used by the AP to initiate a random or scheduled channel access or to trigger or solicit the AMP STAs to transmit its UL PPDU.

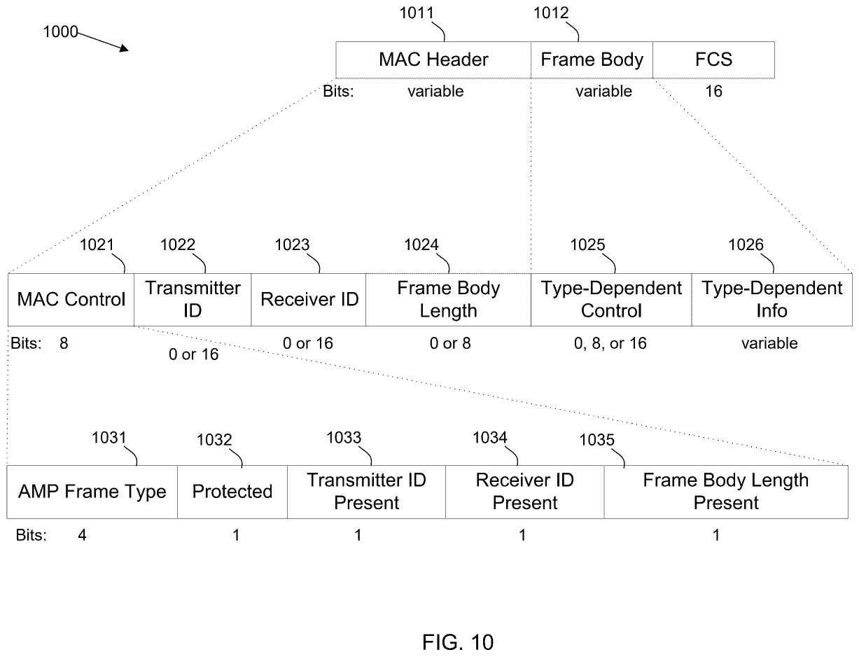

An example embodiment of a format of the AMP frame 1000 is shown in FIG. 10.

With reference to FIG. 10, the AMP Frame 1000 may include a MAC Header field 1011 that may include a MAC Control subfield 1021 having 8 bits. MAC Header field 1011 may include a Transmitter ID subfield 1022 having 0, 12 or 16 bits. The Transmitter ID may be set to the AP ID when the frame is a unicast, multicast, or broadcast frame transmitted by the AMP AP to trigger one, some, or all associated AMP non-AP STAs for scheduled or random channel access. The Transmitter ID may be set to the non-transmitter ID when the frame is a broadcast frame transmitted by the AMP AP to trigger one, some, or all unassociated or/and associated AMP STAs for random channel access. The transmitter ID may be set to the energizer device ID in some cases, for example when the energizer device is not co-located with the AP in a same hardware device. The MAC Header field 1011 may include a Receiver ID subfield 1023 having 0, 12, or 16 bits. The Receiver ID that may be set to an AMP STA ID when the frame is individually addressed to an associated AMP STA non-AP STA. The Receiver ID may be set to the Group ID when the frame is group addressed to all AMP STAs non-AP STAs belonging to the group identified by the AMP group ID (in this case, the frame is group addressed to one or more AMP STAs that are identified by the AMP IDs included in the Frame Body field 1012 and belong to the group identified by the AMP group ID). The MAC Header field 1011 may include the Frame Body Length subfield 1024 having 0, 4, or 8 bits that indicates the length of the Frame Body field 1012. The MAC Header field 1011 may include a Type Dependent Control subfield 1025 having 0, 8, 12, or 16 bits that may include full or partial Time Synchronization Function (TSF) for update or adapt the clock accuracy for the triggered AMP STAs. Another potential location for the Type Dependent Control subfield 1025 could be within the Frame Body field 1012, as shown in FIG. 10.

Further with reference to FIG. 10, The MAC Control subfield 1021 may include one or more of the following: AMP Frame Type subfield 1031 having 3 or 4 bits that is set to identify this frame as the AMP trigger; Protected subfield 1032 having 1 bit (the FCS field contains a 16-bit CRC when the Protected subfield in the Frame Control field is 0 and contains a 16-bit MIC when the Protected subfield in the Frame Control field is set to 1); Transmitter ID Present subfield 1033 having 1 bit (value set to 0 or 1 depending on whether the Trigger frame is broadcast, unicast, or multicast); Receiver ID Present subfield 1034 having 1 bit (value set to 0 or 1 depending on whether the Trigger frame is broadcast, unicast, or multicast); and Frame Body Length Present subfield 1035 or the Frame Body Present subfield (not shown) having 1 bit (value set to 1, which indicates that the Frame Body 1012 is present whose length is indicated in the Frame Body Length subfield 1024 in the MAC Header 1011).

In an implementation, the Frame Body field 1012 may include a Type Dependent Control subfield 1025 including 2-, 3- or 4-bit sub-type field to indicate different sub-types of the AMP Trigger frame and a full or partial Time Synchronization Function (TSF) field for update or adapt the clock accuracy for the triggered AMP STAs. Also, the Frame Body field 1012 may include a Common Info for Channel Access Parameters (e.g., as a Type-dependent Info subfield 1026), including one or more of the following: Channel access mechanism (e.g., TDMA or slotted ALOHA, FDMA, Multi-carrier slotted ALOHA, CDMA, etc.); Number of slots; Slot duration; Slot target start time; Contention Window Size; Probability of Transmission for p-persistent ALOHA which includes the probability p for STA to transmit in a given slot, etc.); Collision Detection Policy which indicates how collisions will be handled (e.g., retransmit via next trigger, NACK feedback, etc.); Time window for next expected trigger to help AMP STA plan wake/sleep schedules; AP Transmit Power; and Time Synchronization Function (TSF). Notably, the Common Info parameters may be included in one Common Info field within the Frame Body field 1012.

The Frame Body field 1012 may include User Info parameters (not shown), including one or more of the following: AMP STA ID; Slot index; Slot duration; Slot target start time; Probability of Transmission for p-persistent ALOHA which includes the probability p for STA to transmit in a given slot, etc.); Collision Detection Policy which indicates how collisions will be handled (e.g., retransmit via next trigger, NACK feedback, etc.); UL MCS; Target Receive Power; RU Allocation; Time window for next expected trigger to help AMP STA plan wake/sleep schedules; 1-bit per STA to indicate whether their previous UL PPDU was received (if leveraged ACK Status indication is used as disclosed herein); segment or fragment number of the acknowledged or unsuccessfully received L PPDU; and Time Synchronization Function (TSF). Notably, the User Info field parameters may be included in one User Info field within the Frame Body held 1012, and one or more User Info fields may be included in the User Info List within the Frame Body field 1012.

The Frame Body field 1012 may include Security related parameters (e.g., A Nonce, MIC, etc.) that may be included in one User Info field or in the Common Info field within the Frame Body field 1012.

In another implementation, a format for the AMP ACK frame that can be used by the AP to acknowledge the successful reception of the AMP STA's UL PPDU is provided. The MAC Header field may include one or more of the following: MAC Control subfield having 8 bits; and Receiver ID subfield having 0, 12, or 16 bits. The Receiver ID may be set to an AMP STA ID when the frame is individually addressed to an associated AMP STA. The MAC Control field may include one or more of the following: AMP Frame Type subfield having 3 or 4 bits that are set to identify this frame as AMP ACK frame; Protected subfield having 1 bit that is set to 0 (the FCS field contains a 16-bit CRC when the Protected subfield in the Frame Control field is 0); Transmitter ID Present subfield having 1 bit that is set to 0 (Transmitter ID doesn't exist in the MAC Header); Receiver ID Present subfield having 1 bit that is set to 1 (Receiver ID exists in the MAC Header); and Frame Body Present or Frame Body Length Present subfield having 1 bit that is set to 0 indicating that the Frame Body is not present.

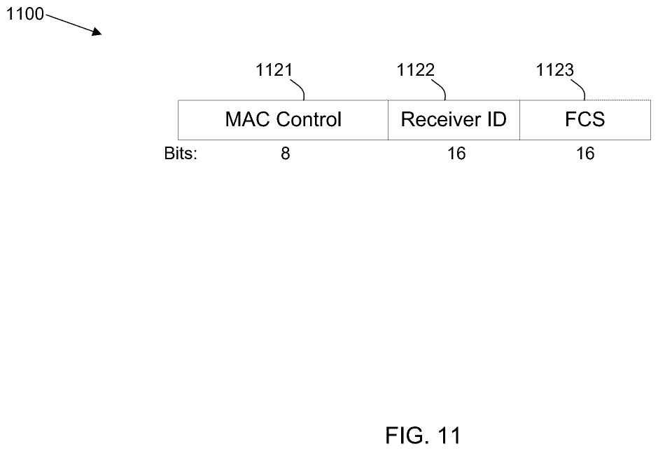

In an implementation, an example format for the AMPACK frame 1100 is shown in FIG. 11.

In an implementation, an example format for the AMP Data or Uplink frame that can be used by the AMP STA to its UL PPDU is provided.

The AMP Data or Uplink frame includes a MAC Header field. With reference to FIG. 11, the MAC Header field may include MAC Control subfield 1121 having 8 bits. The MAC Header field may include Transmitter ID subfield (not shown) having 0, 12 or 16 bits. The Transmitter ID may be set to the AMP STA ID. The Transmitter ID may be set to the non-transmitter random ID when the AMP STA is unassociated with the triggering AP for random channel access. The MAC Header field may include Receiver ID subfield 1122 having 0, 12, or 16 bits. The Receiver ID may be set to the AP ID. The Receiver ID may be set to the energizer device STA ID. The MAC Header field may include the Frame Body Length subfield (not shown) having 4 or 8 bits that indicates the length of the Frame Body field. The MAC Header field may include Type Dependent Control subfield (not shown) having 0, 8, 12, 16, or 24 bits. The AMP ACK frame 1100 may include FCS subfield 1123.

The Frame Body field of an AMP ACK frame may include Type Dependent Control subfield having 0, 8, 12, 16, or 24 bits, including one or more of the following: 2-, 3- or 4-bit sub-type field to indicate different sub-types of the AMP uplink frame transmission, full or partial Time Synchronization Function (TSF) for update or adapt the clock accuracy; segment number or fragment number of the transmitted PPDU, one or more other functions similar to those in the A-control field in IEEE 802.11ax/be/bn standards, such as link adaptation, power saving mode, operating mode, buffer status report, etc.; and energy level status report (the energy level status report can be included as one-bit indication within the AMP Uplink frame or PPDU, for example, as disclosed herein, where a value of 0 indicates a High or non-critical energy level, and a value of 1 indicates a Low or critical energy level).

The MAC Control field of an AMP ACK frame may include one or more of the following: AMP Frame Type subfield having 3 or 4 bits that are set to identify this frame as AMP Data or uplink frame; Protected subfield having 1 bit (the FCS field contains a 16-bit CRC when the Protected subfield in the Frame Control field is 0 and contains a 16-bit MIC when the Protected subfield in the Frame Control field is set to 1); Transmitter ID Present subfield having 1 bit that is set to 0 or 1 depending on whether the Trigger frame is broadcast, unicast, or multicast; Receiver ID Present subfield having 1 bit that is set to 0 or 1 depending on whether the Trigger frame is broadcast, unicast, or multicast; Frame Body Present or Frame Body Length subfield having 1 bit that is set to 1 indicating that the Frame Body is present; and Type-Dependent Control present having 1 bit that is set to 1 indicating that the Type-Dependent Control subfield is present in the MAC header. The Frame Body field includes UL PPDU (i.e., data thereof).

Implementations described herein by way of examples provide an Energy Level Status Report (FLSR) method for AMP STAs to report their current energy state to the network (e.g., to the AP the AMP STA is associated with). Knowing the current energy level of the AMP STA, the AP can make informed decisions about data transmissions based on the reported energy state of the AM STA. This reduces wasted resources and facilitates data loss prevention since the AP may avoid transmitting data and ACK messages or indications (e.g., ACK Status indication) to AMP STAs with insufficient energy to receive and proves such transmissions. Optimized critical data and ACK scheduling is enabled as a result of the AP being able to schedule critical data transmission(s) strategically, for example only when the AP has received an indication that the AMP STA has sufficient energy to process such transmission(s). Retransmissions may be reduced as a result of limiting the probability of the AMP STA failing to receive the transmission as a result of the AMP STA having insufficient energy, which facilitates an overall improvement of network performance.

Implementations described herein provide methods for including energy level information in transmitted data packets (e.g., UL PPDUs) by AMP STAs, limiting the need for dedicated transmissions for indicating energy level information, which improves overhead and decreases overall energy consumption.

Implementations described herein provide methods for energy-aware transmission (e.g., ACK) scheduling by the AP based on received indication of energy level status in an UL transmission from the AMP STA, reducing wasted DL transmissions (e.g., ACK) to the AMP STA in cases where the AMP STA has insufficient energy to receive and/or process such transmissions.

Implementations described herein provide methods for forming efficient and compact AMP frames which can be used for example for AMP Trigger frames, AMP ACK frames, and AMP Data frames exchanged between the AP and AMP STAs, advantageously decreasing signaling overhead and improving energy consumption required for transmitting and receiving operation and processing (e.g., encoding, saving, etc.) thereof.

It will be appreciated that, although specific implementations of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding implementations, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the implementations of the present invention. For example, such an execution may correspond to a simulation of the logical operations as described herein. The software product may additionally or alternatively include number of instructions that enable a computer device to execute operations for configuring or programming a digital logic apparatus in accordance with implementations of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated implementations, not all of them need to be combined to realize the benefits of various implementations of this disclosure. In other words, a system or method designed according to an implementation of this disclosure will not necessarily include all features shown in any one of the Figures or all portions schematically shown in the Figures. Moreover, selected features of one example implementation may be combined with selected features of other example implementations.

Although the present invention has been described with reference to specific features and implementations thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method, comprising:
forming, at an ambient power communication (AMP) station (STA) of a wireless network, an uplink (UL) physical layer protocol data unit (PPDU) that includes a one-bit Energy Level Status indication indicating an energy level of the AMP STA; and
transmitting the UL PPDU to an access point (AP) of the wireless network.

2. The method of claim 1, further comprising:
receiving, at the AMP STA, from the AP, an AMP frame that includes a one-bit acknowledgement (ACK) Status indication indicating one of:
the UL PPDU was received at the AP; and
the UL PPDU was not received at the AP.

3. The method of claim 2, wherein:
the UL PPDU is a first UL PPDU,
the one-bit ACK status indication indicates that the first UL PPDU was received at the AP, and
the AMP frame is one of:
an AMP Trigger frame soliciting a second UL PPDU;
an AMP Trigger frame scheduling a downlink (DL) PPDU;
an AMP ACK frame;
an AMP Beacon frame;
an AMP Data frame; and
another AMP type frame.

4. The method of claim 2, wherein:
the UL PPDU is a first UL PPDU, and
the one-bit ACK status indication indicates that the first UL PPDU was received at the AP, and
the AMP frame is an AMP Trigger frame soliciting a second UL PPDU from the AMP STA.

5. The method of claim 2, wherein the one-bit ACK Status indication indicates that the UL PPDU was not received at the AP, the method further comprising:
retransmitting, by the AMP STA, the UL PPDU to the AP.

6. The method of claim 1, further comprising:
determining, at the AMP STA, that the energy level of the AMP STA is sufficient for transmitting the UL PPDU to the AP; and
receiving, at the AMP STA, from the AP, an acknowledgement (ACK) Status indication indicating one of:
the UL PPDU was received at the AP; and
the UL PPDU was not received at the AP.

7. The method of claim 6, further comprising:
determining, at the AMP STA, that the energy level of the AMP STA is further sufficient for receiving an acknowledgement (ACK) Status indication, from the AP, after transmitting the UL PPDU to the AP.

8. The method of claim 1, wherein the one-bit Energy Level Status indication indicates that the energy level of the AMP STA is below a threshold value, the method further comprising:
receiving, at the AMP STA, from the AP or an energizer device, an energy signal for increasing the energy level of the AMP STA, the energy signal including an acknowledgement (ACK) Status indication indicating one of:
the UL PPDU was received at the AP; and
the UL PPDU was not received at the AP.

9. A method, comprising:
receiving, at an access point (AP) of a wireless network, from an ambient power communication (AMP) station (STA) of the wireless network, an uplink (UL) physical layer protocol data unit (PPDU) that includes a one-bit Energy Level Status indication indicating an energy level of the AMP STA;
determining, in accordance with the one-bit Energy Level Status indication that the AMP STA is operable to receive, from the AP, an acknowledgement (ACK) Status indication;
transmitting, by the AP, to the AMP STA, the (ACK) Status indication to indicate to the AMP STA that the UL PPDU was received at the AP.

10. The method of claim 9, wherein transmitting, by the AP, to the AMP STA, the ACK Status indication comprises:
forming, at the AP, an AMP frame that includes the ACK Status indication, the ACK Status indication consisting of a single bit; and
transmitting, by the AP, the AMP frame to the AMP STA.

11. The method of claim 10, wherein:
the UL PPDU is a first UL PPDU, and
the AMP frame is one of:
an AMP Trigger frame soliciting a second UL PPDU;
an AMP Trigger frame scheduling a downlink (DL) PPDU;
an AMP ACK frame;
an AMP Beacon frame;
an AMP Data frame; and
another AMP type frame.

12. The method of claim 10, wherein:
the UL PPDU is a first UL PPDU;
the ACK Status indication indicates that the first UL PPDU was received at the AP, and
the AMP frame is an AMP Trigger frame soliciting a second UL PPDU from the AMP STA.

13. A method, comprising:
at an access point (AP) of a wireless network,
determining that a previously solicited uplink (UL) physical layer protocol data unit (PPDU) was not received from an ambient power communication (AMP) station (STA) of the wireless network;
sending, to the AMP STA, an acknowledgement (ACK) Status indication indicating that the UL PPDU was not received at the AP, the ACK Status indication also indicating to the AMP STA that the UL PPDU is to transmitted to the AP.

14. The method of claim 9, wherein transmitting, by the AP, to the AMP STA, the ACK Status indication comprises:
forming, at the AP, an energy signal for increasing an energy level of the AMP STA, the energy signal including the ACK Status indication, the ACK Status indication consisting of a single bit; and
transmitting, by the AP, the energy signal to the AMP STA.

15. The method of claim 9, wherein transmitting, by the AP, to the AMP STA, the ACK Status indication comprises:
transmitting, by the AP, to an energizer device, the ACK Status indication, the energizer device being configured to:
form an energy signal for charging the AMP STA, the energy signal including the ACK Status indication, the ACK Status indication consisting of a single bit; and
transmit the energy signal to the AMP STA.

16. A method, comprising:
receiving, at an access point (AP) of a wireless network, from an ambient power communication (AMP) station (STA) of the wireless network, a first uplink (UL) physical layer protocol data unit (PPDU);
forming an AMP frame to solicit a second UL PPDU from the AMP STA, the AMP frame including a one-bit acknowledgement (ACK) Status indication for the first UL PPDU; and
transmitting the AMP frame to the AMP STA.

17. An apparatus in a wireless network, the apparatus comprising a processor and a memory, the memory including machine executable instructions, which, when executed by the processor, configure the apparatus to perform the method of claim 1.

18. An apparatus in a wireless network, the apparatus comprising a processor and a memory, the memory including machine executable instructions, which, when executed by the processor, configure the apparatus to perform the method of claim 9.
